(19) United States
(12) Patent Application Publication
(10) Pub. No.: US 2021/0350766 A1
(43) Pub. Date: Nov. 11, 2021

(54) DISPLAY CONTROL DEVICE, IMAGING DEVICE, DISPLAY CONTROL METHOD, AND DISPLAY CONTROL PROGRAM

(71) Applicant: FUJIFILM Corporation, Tokyo (JP)

(72) Inventor: Kosuke TAKAHASHI, Saitama-shi (JP)

(73) Assignee: FUJIFILM Corporation, Tokyo (JP)

(21) Appl. No.: 17/383,538

(22) Filed: Jul. 23, 2021

Related U.S. Application Data
(63) Continuation of application No. PCT/JP2020/004664, filed on Feb. 6, 2020.

(30) Foreign Application Priority Data
Feb. 14, 2019 (JP) 2019-024793

(51) Int. Cl. G09G 5/10; G09G 3/20

(52) U.S. Cl. CPC G09G 5/10; G09G 3/20; G09G 2360/16; G09G 2360/141; G09G 2320/0626; G09G 2360/145

(57) ABSTRACT

A display control device in which N is defined as a natural number of 2 or more and a motion picture based on motion picture data is displayed on a display unit at N times rate of a frame rate of the motion picture data, includes a display control unit that divides each frame of the motion picture data into N groups in one direction, and displays each of N divided images based on each of the groups on the display unit by dividing into N consecutive display frame periods, P is defined as a numerical value of 1 or more and N-1 or less, and the display control unit is as defined herein.

### CROSS REFERENCE TO RELATED APPLICATION

This is a continuation of International Application No. PCT/JP2020/004664 filed on Feb. 6, 2020, and claims priority from Japanese Patent Application No. 2019-024793 filed on Feb. 14, 2019, the entire disclosure of which is incorporated herein by reference.

### BACKGROUND OF THE INVENTION

### 1. Field of the Invention

The present invention relates to a display control device, an imaging device, a display control method, and a display control program.

### 2. Description of the Related Art

There is black insertion processing of displaying a black image between frames of a motion picture as a method of reducing blurriness of the motion picture which occurs in a case in which a moving object included in a displayed image is tracked in a display device. For example, there is a method of displaying the black image between the frames of the motion picture by turning on the backlight intermittently instead of turning on the backlight at all times. By performing the black insertion processing, the display characteristics of a hold-type display such as a liquid crystal display device can be brought closer to the display characteristics of an impulse-type display, and the blurriness of the motion picture can be reduced. JP2002-040390A and JP2012-037858A disclose a black insertion technique.

### SUMMARY OF THE INVENTION

In order to enhance the effect of reducing the blurriness of the motion picture, there is a method of making the display frame rate higher than the frame rate of motion picture data and shortening the black insertion time. In this method, the image cannot be displayed until readout of the frame of the motion picture data is completed, so that a time lag occurs in the display of the motion picture. JP2002-040390A and JP2012-037858A do not disclose a method of effectively reducing the time lag.

The present invention has been made in view of the above circumstances, and is to provide a display control device, an imaging device, a display control method, and a display control program capable of reducing the time lag until the start of motion picture display while reducing the blurriness of the motion picture.

A display control device according to an aspect of the present invention is a display control device in which N is defined as a natural number of 2 or more and a motion picture based on motion picture data is displayed on a display unit at N times a frame rate of the motion picture data, the device comprising a display control unit that divides each frame of the motion picture data into N groups in one direction, and displays each of N divided images based on each of the groups on the display unit by dividing into N consecutive display frame periods, in which P is defined as a numerical value of 1 or more and N-1 or less, and the display control unit displays each of the divided images on a display area of the display unit which corresponds to each of the divided images in N-P display frame periods of the N display frame periods, and displays a specific image different from the motion picture data in P display frame periods of the N display frame periods.

An imaging device according to another aspect of the present invention is an imaging device comprising the display control device according to the aspect of the present invention, an imaging element, and the display unit.

A display control method according to still another aspect of the present invention is a display control method in which N is defined as a natural number of 2 or more and a motion picture based on motion picture data is displayed on a display unit at N times a frame rate of the motion picture data, the method comprising a display control step of dividing each frame of the motion picture data into N groups in one direction, and displaying each of N divided images based on each of the groups on the display unit by dividing into N consecutive display frame periods, in which P is defined as a numerical value of 1 or more and N-1 or less, and in the display control step, each of the divided images is displayed on a display area of the display unit which corresponds to each of the divided images in N-P display frame periods of the N display frame periods, and a specific image different from the motion picture data is displayed in P display frame periods of the N display frame periods.

A display control program according to still another aspect of the present invention is a display control program that causes a computer to execute a display control method in which N is defined as a natural number of 2 or more and a motion picture based on motion picture data is displayed on a display unit at N times a frame rate of the motion picture data, in which the display control method includes a display control step of dividing each frame of the motion picture data into N groups in one direction, and displaying each of N divided images based on each of the groups on the display unit by dividing into N consecutive display frame periods, P is defined as a numerical value of 1 or more and N-1 or less, and in the display control step, each of the divided images is displayed on a display area of the display unit which corresponds to each of the divided images in N-P display frame periods of the N display frame periods, and a specific image different from the motion picture data is displayed in P display frame periods of the N display frame periods.

According to the present invention, it is possible to provide a display control device, an imaging device, a display control method, and a display control program capable of reducing the time lag until the start of motion picture display while reducing the blurriness of the motion picture.

### BRIEF DESCRIPTION OF THE DRAWINGS

FIG. 1 is a diagram showing a schematic configuration of a digital camera 100, which is an embodiment of an imaging device of the present invention.

FIG. 2 is a schematic plan view showing a schematic configuration of a display unit 23 shown in FIG. 1.

FIG. 3 is a schematic plan view showing a schematic configuration of an imaging element 6 shown in FIG. 1.

FIG. 4 is a schematic view for explaining a division example (N=3) of one frame of a motion picture.

FIG. 5 is a schematic view for explaining another division example (N=3) of one frame of the motion picture.

FIG. 6 is a schematic view for explaining still another division example (N=2) of one frame of the motion picture.

FIG. 7 is a timing chart for explaining the operation at the time of live view display control by a system control unit 11.

FIG. 8 is a timing chart for explaining a first modification example of the operation at the time of live view display control by the system control unit 11.

FIG. 9 is a timing chart for explaining a second modification example of the operation at the time of live view display control by the system control unit 11.

FIG. 10 is a timing chart for explaining a third modification example of the operation at the time of live view display control by the system control unit 11.

FIG. 11 is a view showing the appearance of a smartphone 200, which is another embodiment of the imaging device of the present invention.

FIG. 12 is a block diagram showing a configuration of the smartphone 200 shown in FIG. 11.

### DESCRIPTION OF THE PREFERRED EMBODIMENTS

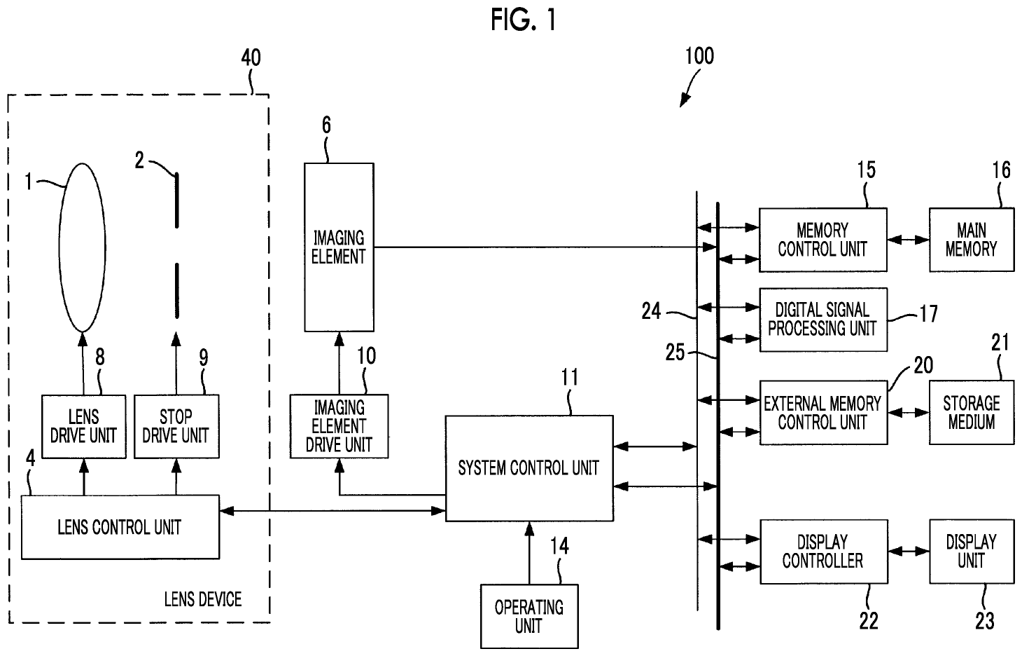

Hereinafter, embodiments of the present invention will be described with reference to the drawings. FIG. 1 is a diagram showing a schematic configuration of a digital camera 100 which is an embodiment of an imaging device of the present invention. The digital camera 100 shown in FIG. 1 comprises a lens device 40 which includes an imaging lens 1, a stop 2, a lens control unit 4, a lens drive unit 8, and a stop drive unit 9.

The lens device 40 may be attachable to and detachable from a main body of the digital camera 100, or may be integrated with the main body of the digital camera 100. The imaging lens 1 and the stop 2 configure an imaging optical system, and the imaging lens 1 includes a focus lens or a zoom lens which can be moved in an optical axis direction.

The focus lens is a lens for adjusting the focus of the imaging optical system, and is composed of a single lens or a plurality of lenses. By the focus lens being moved in the optical axis direction, a position of a principal point of the focus lens is changed along the optical axis direction, and a focal position on a subject side is changed. As the focus lens, a liquid lens of which the focus can be adjusted by changing the position of the principal point in the optical axis direction by electrical control may be used.

The lens control unit 4 of the lens device 40 is configured to be able to communicate with a system control unit 11 of the digital camera 100 by wire or wirelessly.

In accordance with the command from the system control unit 11, the lens control unit 4 controls the focus lens included in the imaging lens 1 via the lens drive unit 8 to change the position of the principal point of the focus lens or controls the opening amount of the stop 2 via the stop drive unit 9.

The digital camera 100 further comprises an imaging element 6 configured by a complementary metal oxide semiconductor (CMOS) image sensor which images a subject through the imaging optical system.

The imaging element 6 has an imaging surface in which a plurality of pixels are arranged two-dimensionally, and the subject image formed on the imaging surface by the imaging optical system is converted into pixel signals by the plurality of pixels and output the converted signals. Hereinafter, a set of the pixel signals output from the pixels of the imaging element 6 is referred to as a captured image signal.

The system control unit 11 which controls the entire electric control system of the digital camera 100 in an integrated manner drives the imaging element 6 via an imaging element drive unit 10, and outputs the subject image captured through the imaging optical system of the lens device 40 as the captured image signal.

In a case in which the digital camera 100 is set to an imaging mode, the system control unit 11 starts continuous imaging of the subject by the imaging element 6, and performs a live view display control of displaying, on the display unit 23, a live view image based on motion picture data which includes a plurality of captured image signals output from the imaging element 6 by the continuous imaging. Further, the system control unit 11 performs a recorded motion picture reproduction control of reading out the motion picture data stored in a storage medium 21 and displaying a motion picture based on the motion picture data on the display unit 23.

The system control unit 11 controls the entire digital camera 100 in an integrated manner, and the hardware structure includes various processors that execute the program and perform processing.

Examples of the various processors include a central processing unit (CPU), which is a general-purpose processor that executes a program and performs various processing, programmable logic device (PLD), which is a processor whose circuit configuration can be changed after manufacturing, such as field programmable gate array (FPGA), or a dedicated electric circuit, which is a processor having a circuit configuration specially designed for executing specific processing such as an application specific integrated circuit (ASIC), and the like. The structure of these various processors is, more specifically, an electric circuit in which circuit elements such as semiconductor elements are combined.

The system control unit 11 may be configured by one of the various processors, or may be configured by a combination of two or more processors of the same type or different types (for example, a combination of a plurality of the FPGAs or a combination of the CPU and the FPGA).

Further, the electric control system of the digital camera 100 comprises a main memory 16 configured by a random access memory (RAM), a memory control unit 15 that performs a control of data storage in the main memory 16 and readout of the data from the main memory 16, a digital signal processing unit 17 that performs digital signal processing on the captured image signal output from the imaging element 6 and generates captured image data in accordance with various formats such as a joint photographic experts group (JPEG) format, an external memory control unit 20 that performs a control of data storage in the storage medium 21 and readout of the data from the storage medium 21, the display unit 23 configured by an organic electroluminescence (EL) panel, a liquid crystal panel, or the like, and a display controller 22 that controls the display of the display unit 23.

The storage medium 21 is a semiconductor memory such as a flash memory built in the digital camera 100, or a portable semiconductor memory which can be attached to and detached from the digital camera 100.

The memory control unit 15, the digital signal processing unit 17, the external memory control unit 20, and the display controller 22 are connected to each other by a control bus 24 and a data bus 25, and are controlled by the command from the system control unit 11.

The display controller 22 includes various processors described above as an example, which execute a program and perform processing, and a display memory that holds data of an image to be displayed.

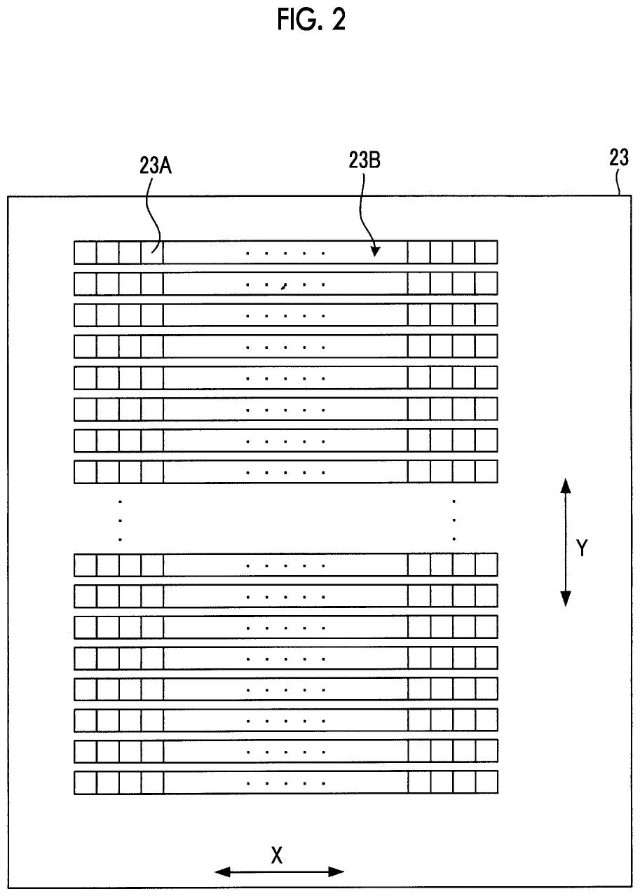

FIG. 2 is a schematic plan view showing a schematic configuration of the display unit 23 shown in FIG. 1. The display unit 23 has a display surface on which a plurality of display pixel rows 23B, which includes a plurality of display pixels 23A arranged in a row direction X, are arranged in a column direction Y orthogonal to the row direction X.

The display controller 22 performs drawing update processing of sequentially updating a line image drawn on the display pixel row 23B from the display pixel row 23B on the upper end in the column direction Y of the display unit 23 toward the display pixel row 23B on the lower end to display the image which includes the same number of line images of the display pixel row 23B on the display unit 23.

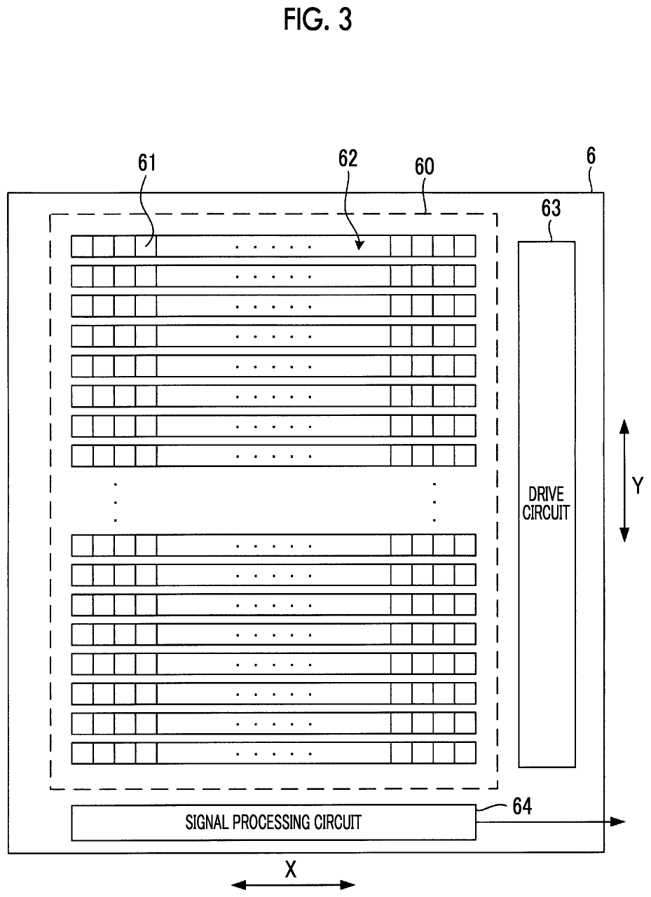

FIG. 3 is a schematic plan view showing a schematic configuration of the imaging element 6 shown in FIG. 1. The imaging element 6 comprises an imaging surface 60 on which a plurality of pixel rows 62, which includes a plurality of pixels 61 arranged in the row direction X, are arranged in the column direction Y orthogonal to the row direction X, a drive circuit 63 which drives the pixels 61 which are arranged on the imaging surface 60, and a signal processing circuit 64 which processes the pixel signal read out from each of the pixels 61 of the pixel row 62 arranged on the imaging surface 60 into a signal line.

In the following, in FIG. 3, an end portion of the imaging surface 60 on the upper side in the column direction Y is referred to as an upper end, and an end portion of the imaging surface 60 on the lower side in the column direction Y is referred to as a lower end.

The signal processing circuit 64 shown in FIG. 3 performs sampling two correlation pile processing on the pixel signal read out from each pixel 61 of the pixel row 62 into the signal line, and converts the pixel signal after the sampling two correlation pile processing into a digital signal and outputs the converted digital signal to the data bus 25 (see FIG. 1). The signal processing circuit 64 is controlled by the imaging element drive unit 10.

In one example, the total number M of the pixel rows 62 formed on the imaging surface 60 of the imaging element 6 is more than the total number m of the display pixel rows 23B formed on the display unit 23.

In the digital camera 100, among the M pixel rows 62 formed on the imaging surface 60, m pixel rows 62 which are arranged at regular intervals in the column direction Y are set as display target pixel rows. In the following, the pixel row 62 set as the display target pixel row is also referred to as a display target pixel row 62.

The display target pixel row 62, which is the i-th (i is 1 to m) from the upper end of the imaging surface 60, is managed in association with the display pixel row 23B, which is the i-th from the upper end of the display surface of the display unit 23.

In some cases, the total number M and the total number m are the same. In that case, the display target pixel row 62, which is the j-th (j is 1 to M) from the upper end of the imaging surface 60, is managed in association with the display pixel row 23B, which is the j-th from the upper end of the display surface of the display unit 23.

At the time of the live view display control, the system control unit 11 executes a program including the display control program to perform the display control of displaying the motion picture based on the motion picture data output from the imaging element 6 on the display unit 23 at N times the frame rate of the motion picture data. In the present specification, the system control unit 11 configures a display control device.

In a state in which continuous imaging for live view image display is performed by the imaging element 6, the pixel signals are read out from the pixels 61 included in all of the display target pixel rows 62 on the imaging surface 60 of the imaging element 6, and the set of the read out pixel signals (captured image signals) configures one frame of the motion picture data.

In a case in which one frame of the motion picture data is read out from the imaging element 6, the system control unit 11 divides the one frame into N groups in the column direction Y, and performs a readout control of the frame sequentially for each group. The column direction Y corresponds to a readout direction of the pixel signal from an imaging element 6. N is a value of 2 or more, and an upper limit value thereof is the same as the total number m of the display pixel rows 23B included in the display unit 23.

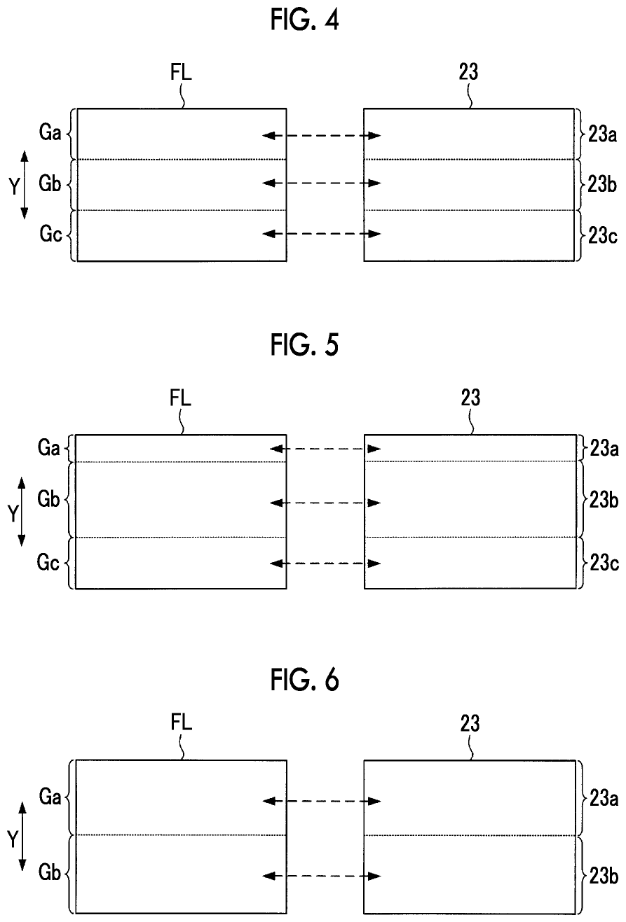

FIG. 4 is a schematic view for explaining a division example (N=3) of one frame of the motion picture. FIG. 4 shows one frame FL of the motion picture which is output from the imaging element 6. An upper end of a frame FL in FIG. 4 corresponds to the upper end side of the imaging surface 60, and a lower end of the frame FL in FIG. 4 corresponds to the lower end side of the imaging surface 60. That is, the upper end side of the frame FL in FIG. 4 indicates a portion output from the upper end side of the imaging surface 60, and the lower end side of the frame FL in FIG. 4 indicates a portion output from the lower end side of the imaging surface 60. In the example of FIG. 4, the frame FL is evenly divided into three in the column direction Y, and is configured by a group Ga, a group Gb, and a group Gc.

As described above, each of the display target pixel rows 62 of the imaging element 6 is managed in association with the display pixel row 23B of the display unit 23. Therefore, in the same manner, the group Ga is managed in association with a display area 23a on the display unit 23 on which the display pixel rows 23B, which corresponds to the display target pixel row 62 as the output source of the group Ga are arranged.

In the same manner, the group Gb is managed in association with a display area 23b on the display unit 23 on which the display pixel rows 23B, which corresponds to the display target pixel row 62 as the output source of the group Gb, are arranged.

In the same manner, the group Gc is managed in association with a display area 23c on the display unit 23 on which the display pixel rows 23B, which corresponds to the display target pixel row 62 as the output source of the group Gc are arranged.

FIG. 5 is a schematic view for explaining another division example (N=3) of one frame of the motion picture. The division example shown in FIG. 5 is the same as that of FIG. 4 except that a boundary position between the group Ga and the group Gb shown in FIG. 4 is moved to the upper end side. As shown in FIG. 5, in a case in which the boundary position of the group Ga and the group Gb is changed, the boundary position of the display area 23a and the display area 23b, which corresponds to these is also changed.

FIG. 6 is a schematic view for explaining still another division example (N=2) of one frame of the motion picture. In the example of FIG. 6, the frame FL is evenly divided into two in the column direction Y, and is configured by the group Ga and the group Gb.

Also, in the example of FIG. 6, the group Ga is managed in association with a display area 23a on the display unit 23 on which the display pixel rows 23B, which corresponds to the display target pixel row 62 which is the output source of the group Ga are arranged. Also, the group Gb is managed in association with a display area 23b on the display unit 23 on which the display pixel rows 23B, which corresponds to the display target pixel row 62 which is the output source of the group Gb are arranged.

In the display control, the system control unit 11 displays each of N divided images based on each of the groups read out from the imaging element 6 on the display unit 23 by dividing into N display frame periods. The display frame period is a period (update interval of the displayed image of the display unit 23) from falling of a vertical synchronization signal of the display unit 23, which will be described below, to the next falling.

In a case in which two adjacent groups among the N groups, which are obtained by dividing any frame, are defined as a first group and a second group, the N display frame periods in which the divided images based on the first group are displayed and the N display frame periods in which the divided images based on the second group are displayed are set to deviate by one display frame period.

In the case of the division example shown in FIG. 4 or 5, the system control unit 11 performs a control of displaying the divided image based on the group Ga of the frame FL on the display area 23a of the display unit 23, displaying the divided image based on the group Gb of the frame FL on the display area 23b of the display unit 23, and displaying the divided image based on the group Gc of the frame FL on the display area 23c of the display unit 23.

In the case of the division example shown in FIG. 6, the system control unit 11 performs a control of displaying the divided image based on the group Ga of the frame FL on the display area 23a of the display unit 23, and displaying the divided image based on the group Gb of the frame FL on the display area 23b of the display unit 23.

Then, in the display control, in a case in which P is a numerical value of 1 or more and (N-1) or less, the system control unit 11 performs a control of displaying each of the divided image in N-P display frame periods among the N display frame periods on each display area on which each of the divided images which configure one frame FL is displayed, and displaying a specific image for reducing the blurriness of the motion picture, which is different from the frame FL in the P display frame periods among the N display frame periods.

The specific image for reducing the blurriness of the motion picture is an image for reducing the blurriness of the motion picture which occurs when a person tracks a moving object, and is a black image, specifically. The specific image need only be an image other than the frame which is a display target and the image having a brightness that does not leave an afterimage of the frame, for example, a white image, a gray image, a random noise image, or the like can also be used in addition to the black image.

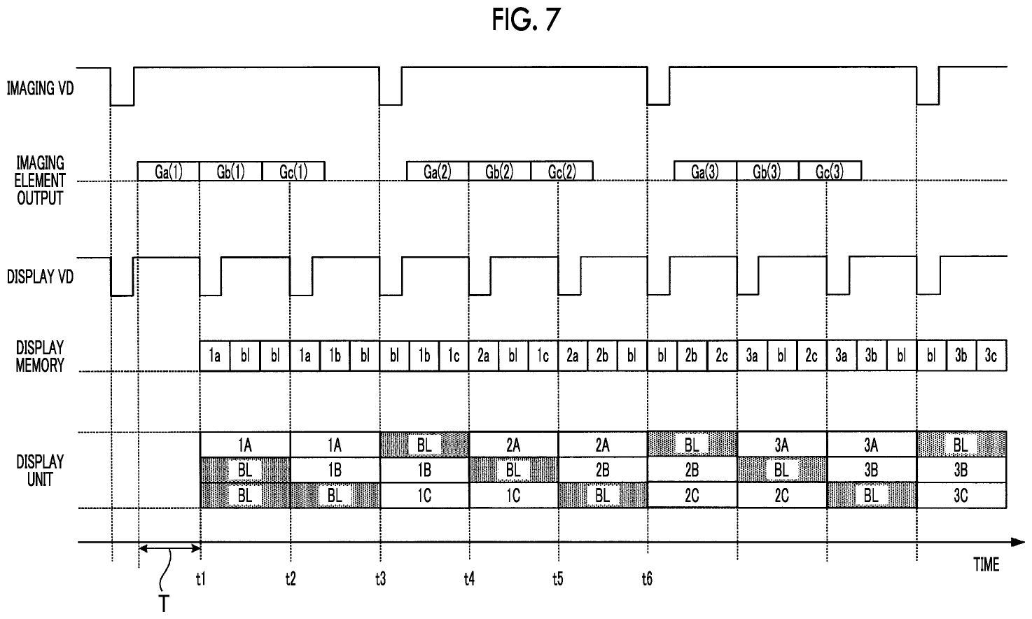

FIG. 7 is a timing chart for explaining the operation at the time of the live view display control by the system control unit 11. FIG. 7 shows an operation example in a case in which the example shown in FIG. 4 is adopted as the division example of the frame of the motion picture data.

The “imaging VD” shown in FIG. 7 indicates the vertical synchronization signal of the imaging element 6, which decides the frame rate of the motion picture data. The “display VD” shown in FIG. 7 indicates the vertical synchronization signal of the display unit 23, which decides a display rate of the motion picture data. FIG. 7 shows an example (example of N=3) in which the display rate is set to three times the frame rate of the motion picture data. In FIG. 7, the period from the falling of the display VD to the next falling configures the display frame period.

The “imaging element output” shown in FIG. 7 indicates a frame output from the imaging element 6. In the example of FIG. 7, a first frame is divided into a group Ga(1), a group Gb(1), and a group Gc(1), which are read out sequentially. Further, a second frame is divided into a group Ga(2), a group Gb(2), and a group Gc(2), which are read out sequentially. Further, a third frame is divided into a group Ga(3), a group Gb(3), and a group Gc(3), which are read out sequentially.

The “display memory” shown in FIG. 7 indicates data which is stored in the display memory of the display controller 22. The “display unit” shown in FIG. 7 indicates an image displayed in the display area 23a, the display area 23b, and the display area 23c of the display unit 23, which are shown in FIG. 4.

In FIG. 7, of the data stored in the display memory, data indicated by “Ka” (K is any of 1, 2, or 3) is display data obtained by processing the group Ga(K). Further, “Kb” is display data obtained by processing the group Gb(K). Further, “Kc” is display data obtained by processing the group Gc(K). Further, “bl” is black display data for displaying the black image which is an example of the specific image.

In FIG. 7, among the divided images displayed on the display unit 23, “KA” (K is any of 1, 2, or 3) is the divided image displayed based on the display data Ka. Also, “KB” is a divided image displayed based on the display data Kb. Also, “KC” is a divided image displayed based on the display data Kc. Also, “BL” is a black image displayed based on the black display data bl.

In a case in which the system control unit 11 completes the readout of the group Ga(1) of the first frame from the imaging element 6, the group Ga(1) is processed and display data 1a is generated. Thereafter, at a display update timing t1, in the display memory, the system control unit 11 stores the display data la in an area corresponding to the display area 23a, stores the black display data bl in areas corresponding to the display area 23b and the display area 23c, and commands the display controller 22 to display the data in the display memory. As a result, in the display unit 23, a divided image 1A is displayed in the display area 23a, and a black image BL is displayed in the display area 23b and the display area 23c.

Subsequently, in a case in which the system control unit 11 completes the readout of the group Gb(1) of the first frame from the imaging element 6, the group Gb(1) is processed and display data 1b is generated.

Thereafter, at a display update timing t2, in the display memory, the system control unit 11 leaves the data as it is in the areas corresponding to the display area 23a and the display area 23c, overwrites the display data lb on the area corresponding to the display area 23b, and commands the display controller 22 to perform display update of the display area 23b. Therefore, in the display unit 23, the display content of the display area 23b is updated from the black image BL to a divided image 1B.

Subsequently, in a case in which the system control unit 11 completes the readout of the group Gc(1) of the first frame from the imaging element 6, the group Gc(1) is processed and display data 1c is generated.

Thereafter, at a display update timing t3, in the display memory, the system control unit 11 leaves the data as it is in the area corresponding to the display area 23b, overwrites the display data 1c on the area corresponding to the display area 23c, overwrites the black display data bl on the area corresponding to display area 23a, and commands the display controller 22 to perform display update of the display areas 23a and 23c. Therefore, in the display unit 23, the display content of the display area 23a is updated from the divided image 1A to the black image BL, and the display content of the display area 23c is updated from the black image BL to a divided image 1C.

Subsequently, in a case in which the system control unit 11 completes the readout of the group Ga(2) of the second frame from the imaging element 6, the group Ga(2) is processed and display data 2a is generated.

Thereafter, at a display update timing t4, in the display memory, the system control unit 11 leaves the area corresponding to the display area 23c as it is, overwrites the display data 2a on the area corresponding to the display area 23a, overwrites the black display data bl on the area corresponding to display area 23b, and commands the display controller 22 to perform display update of the display area 23a and the display area 23b. Therefore, in the display unit 23, the display content of the display area 23a is updated from the black image BL to a divided image 2A, and the display content of the display area 23b is updated from the divided image 1B to the black image BL.

Subsequently, in a case in which the system control unit 11 completes the readout of the group Gb(2) of the second frame from the imaging element 6, the group Gb(2) is processed and display data 2b is generated.

Thereafter, at a display update timing t5, in the display memory, the system control unit 11 leaves the area corresponding to the display area 23a as it is, overwrites the display data 2b on the area corresponding to the display area 23b, overwrites the black display data bl on the area corresponding to display area 23c, and commands the display controller 22 to perform display update of the display area 23b and the display area 23c. Therefore, in the display unit 23, the display content of the display area 23b is updated from the black image BL to a divided image 2B, and the display content of the display area 23c is updated from the divided image 1C to the black image BL.

Subsequently, in a case in which the system control unit 11 completes the readout of the group Gc(2) of the second frame from the imaging element 6, the group Gc(2) is processed and display data 2c is generated.

Thereafter, at a display update timing t6, in the display memory, the system control unit 11 leaves the area corresponding to the display area 23b as it is, overwrites the display data 2c on the area corresponding to the display area 23c, overwrites the black display data bl on the area corresponding to display area 23a, and commands the display controller 22 to perform display update of the display area 23a and the display area 23c. Therefore, in the display unit 23, the display content of the display area 23c is updated from the black image BL to a divided image 2C, and the display content of the display area 23a is updated from the divided image 2A to the black image BL. Thereafter, the same processing is repeated.

As can be seen from the image of the display unit 23 shown in FIG. 7, under the control of the system control unit 11, each of the divided image KA, the divided image KB, and the divided image KC, which configure the image, based on each frame is displayed by dividing into three display frame periods, and the black image is inserted instead of the divided image in one of these three display frames.

In a case in which description is made with the divided image KA as an example, the divided image 1A displayed in the display area 23a is displayed by dividing into the three display frame periods of the display frame period between the update timing t1 and the update timing t2, the display frame period between the update timing t2 and the update timing t3, and the display frame period between the update timing t3 and the update timing t4, and the black image BL is inserted in the display frame period between the update timing t3 and the update timing t4.

Further, the divided image 1B displayed in the display area 23b is displayed by dividing into the three display frame periods of the display frame period between the update timing t2 and the update timing t3, the display frame period between the update timing t3 and the update timing t4, and the display frame period between the update timing t4 and the update timing t5, and the black image BL is inserted in the display frame period between the update timing t4 and the update timing t5.

Further, the divided image 1C displayed in the display area 23c is displayed by dividing into the three display frame periods of the display frame period between the update timing t3 and the update timing t4, the display frame period between the update timing t4 and the update timing t5, and the display frame period between the update timing t5 and the update timing t6, and the black image BL is inserted in the display frame period between the update timing t5 and the update timing t6.

Therefore, in a case in which the displayed image is viewed by integrating accumulating the time, the black image is inserted at the rate of once in the three display frame periods, and it is possible to reduce the blurriness of the motion picture.

Further, as shown in FIG. 7, time T from the timing at which the readout of each frame is started to the start of displaying the divided image based on the frame can be the time sufficiently shorter than the time required to generate one frame defined by the imaging VD. As a result, the display of the live view image can be started at high speed, and the possibility of missing a shutter chance can be reduced.

The system control unit 11 may variably control a division method instead of fixing the division method for each frame of the motion picture data to one. For example, the system control unit 11 may switch between the frame division setting shown in FIG. 4 and the frame division setting shown in FIG. 5 for one motion picture data.

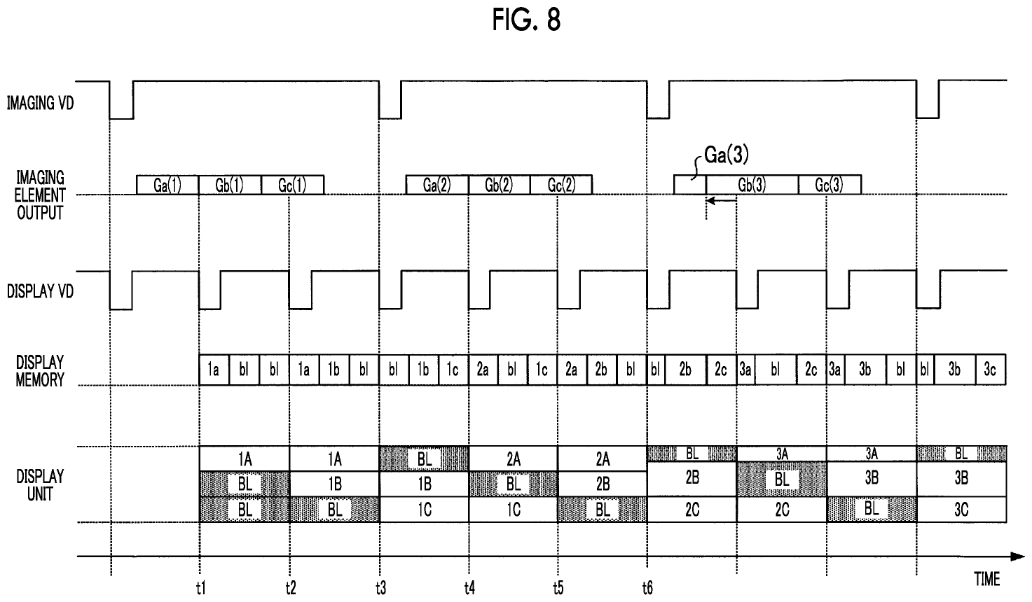

FIG. 8 is a timing chart for explaining a first modification example of the operation at the time of the live view display control by the system control unit 11. The timing chart shown in FIG. 8 shows the operation in a case in which the system control unit 11 switches the division setting for every two frames.

Specifically, the system control unit 11 selects the division setting shown in FIG. 4 for the first frame and the second frame, and selects the division setting shown in FIG. 5 for the third frame and a fourth frame. Thereafter, the system control unit 11 alternately repeats the division setting of FIG. 4 and the division setting of FIG. 5.

In FIG. 8, the division setting shown in FIG. 4 is selected for the frames acquired until the update timing t6. Further, the division setting shown in FIG. 5 is selected for the frames acquired after the update timing t6.

In this case, in a case in which the readout of the group Gc(2) is completed, the system control unit 11 resets the display memory. Then, in the reset display memory, the system control unit 11 stores the processed display data 2c of the group Gc(2) in a memory area for the display area 23c in new division setting which corresponds to the group Gc, stores the display data 2b which has been already generated in a memory area for the display area 23b in new division setting which corresponds to the group Gb, stores the black display data bl in a memory area for the display area 23a in new division setting which corresponds to the group Ga, and commands to update the displayed image.

In response to this command, the display controller 22 displays, on the display unit 23, the black image BL in the display area 23a shown in FIG. 5, displays the divided image 2B in the display area 23b shown in FIG. 5, and displays the divided image 2C in the display area 23c shown in FIG. 5. Thereafter, the display of each divided image is updated in accordance with the new division setting.

According to the operation example shown in FIG. 8, the boundary positions of the three divided images displayed on the display unit 23 are not fixed, and thus tearing can be prevented and the displayed image quality can be improved.

In the operation example shown in FIG. 8, it is preferable that the system control unit 11 control the temporal average position of the boundary positions of the three groups (each of the boundary positions of the group Ga and the group Gb and the boundary positions of the group Gb and the group Gc) in a fixed manner. As a result, the displayed image quality can be further improved.

The system control unit 11 may variably control the insertion frequency of the black image in a case in which each divided image is displayed by dividing into N display frame periods.

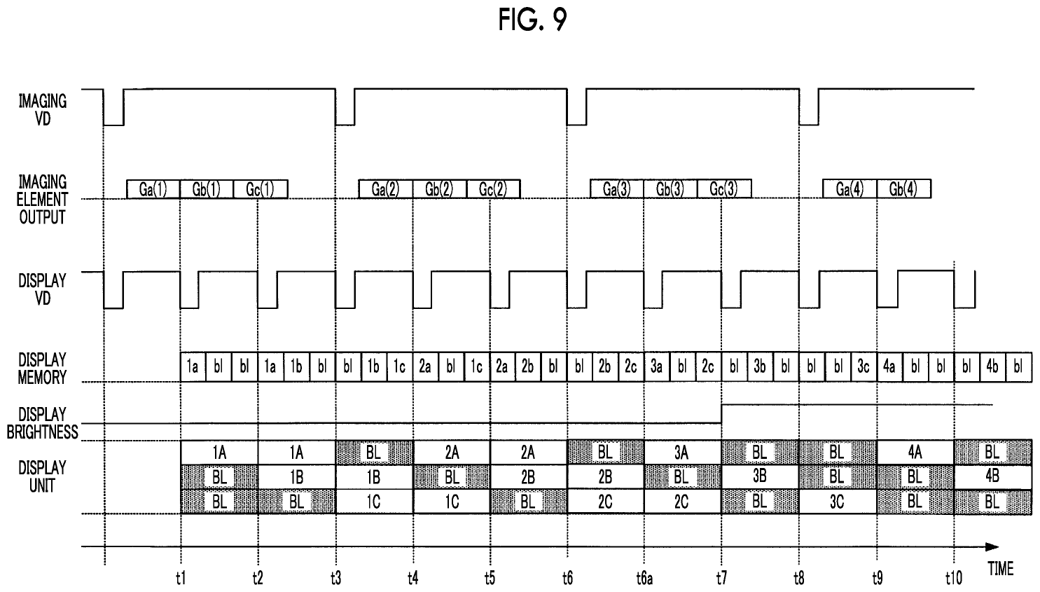

FIG. 9 is a timing chart for explaining a second modification example of the operation at the time of the live view display control by the system control unit 11. In the second modification example, the system control unit 11 performs, with respect to the first frame and the second frame, a control (control in which P is defined as 1) of displaying the divided image in two display frame periods among the three display frame periods used for displaying each divided image and displaying the black image in one display frame period, and performs, with respect to the third and subsequent frames, a control (control in which P is defined as 2) of displaying the divided image in one display frame period among the three display frame periods used for displaying each divided image and displaying the black image in the two display frame periods.

More specifically, the operation to the display update timing t7 two times after the update timing t6 is the same as the operation of FIG. 7. In a case in which the system control unit 11 completes the readout of the group Gb(3) of the third frame from the imaging element 6, the group Gb(3) is processed and display data 3b is generated.

Thereafter, at a display update timing t7, in the display memory, the system control unit 11 overwrites the display data 3b on the area corresponding to the display area 23b, overwrites the black display data bl on the areas corresponding to the display area 23a and the display area 23c, and commands the display controller 22 to perform display update of the display areas 23a, 23b, and 23c. Therefore, in the display unit 23, the display content of the display area 23a is updated from a divided image 3A to the black image BL, the display content of the display area 23b is updated from the black image BL to a divided image 3B, and the display content of the display area 23c is updated from the divided image 2C to the black image BL.

In a case in which the system control unit 11 completes the readout of the group Gc(3) of the third frame from the imaging element 6, the group Gc(3) is processed and display data 3c is generated.

Thereafter, at a display update timing t8, in the display memory, the system control unit 11 leaves the area corresponding to the display area 23a as it is, overwrites the black display data bl on the area corresponding to the display area 23b, overwrites the display data 3c on the area corresponding to display area 23c, and commands the display controller 22 to perform display update of the display areas 23b and 23c. Therefore, in the display unit 23, the display content of the display area 23b is updated from the divided image 3B to the black image BL, and the display content of the display area 23c is updated from the black image BL to the divided image 3C.

Thereafter, the display content of the display unit 23 is that a divided image 4A based on the group Ga(4) of the fourth frame is displayed in the display area 23a, and the black image BL is displayed in the display area 23b and the display area 23c.

Thereafter, the display content of the display unit 23 is that the black image BL is displayed in the display area 23a, a divided image 4B based on the group Gb(4) of the fourth frame is displayed in the display area 23b, and the black image BL is displayed in the display area 23c.

In the example of FIG. 9, the divided image 3A displayed in the display area 23a is displayed by dividing into the three display frame periods of the display frame period between the update timing t6a and the update timing t7, the display frame period between the update timing t7 and the update timing t8, and the display frame period between the update timing t8 and the update timing t9, and the black image BL is inserted in the two display frame periods after the update timing t7.

Further, the divided image 3B displayed in the display area 23b is displayed by dividing into the three display frame periods of the display frame period between the update timing t7 and the update timing t8, the display frame period between the update timing t8 and the update timing t9, and the display frame period between the update timing t9 and the update timing t10, and the black image BL is inserted in the two display frame periods after the update timing t8.

Further, the divided image 3C displayed in the display area 23c is displayed by dividing into the three display frame periods of the display frame period between the update timing t8 and the update timing t9, the display frame period between the update timing t9 and the update timing t10, and the display frame period between the update timing t10 and the subsequent update timing and the black image BL is inserted in the two display frame periods after the update timing t9.

As a result of the insertion frequency of the black image being changed in the middle, the average brightness of the images displayed on the display unit 23 in the display frame periods after the update timing t7 in FIG. 9 is lower than the average brightness of the image displayed on the display unit 23 in each of the display frame periods from the update timing t2 to update timing t7.

Therefore, the system control unit 11 performs brightness adjustment to match the average brightness of the images displayed in each display frame period after the update timing t7 in which the change in the insertion frequency of the black image is reflected in the displayed image with the average brightness of the images displayed in each display frame period before the update timing t7.

By performing the brightness adjustment, even in a case in which the value of P is dynamically changed depending on the situation in order to reduce the blurriness of the motion picture, the brightness of the displayed image can be prevented from flickering and the display quality can be improved.

The system control unit 11 may switch between the frame division setting shown in FIG. 4 and the frame division setting shown in FIG. 6 for one motion picture data.

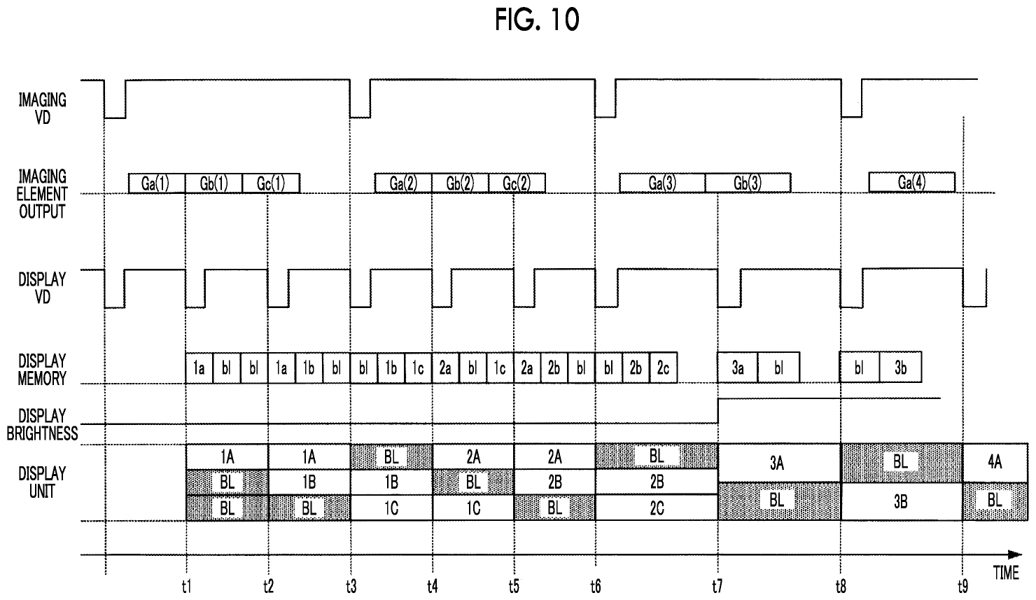

FIG. 10 is a timing chart for explaining a third modification example of the operation at the time of the live view display control by the system control unit 11. In the third modification example, the system control unit 11 performs, with respect to the first frame and the second frame, a control (control in which N is defined as 3) of dividing the frame into three and displaying each of the divided images by dividing into the three display frame periods, and performs, with respect to the third and subsequent frames, a control (control in which N is defined as 2) of dividing the frame into two and displaying each of the divided images by dividing into the two display frame periods.

More specifically, the operation to the update timing t6 is the same as the operation of FIG. 7. In the example of FIG. 10, at the update timing t6, the number of divisions of frames of the motion picture data is changed from 3 to 2. In a case in which the number of divisions of frames is changed to 2, the display VD is changed. As a result, the image displayed on the display unit 23 at the update timing t6 continues to be displayed until the next extended update timing t7.

In a case in which the system control unit 11 completes the readout of the group Ga(3) of the third frame from the imaging element 6, the group Ga(3) is processed and display data 3a is generated. Thereafter, at a display update timing t7, the system control unit 11 resets the display memory, in the reset display memory, stores the display data 3a in an area corresponding to the display area 23a shown in FIG. 6, stores the black display data bl in an area corresponding to the display area 23b shown in FIG. 6, and commands the display controller 22 to perform display update of the display areas 23a and 23b. Therefore, in the display unit 23, the divided image 3A is displayed in the display area 23a shown in FIG. 6, and the black image BL is displayed in the display area 23b shown in FIG. 6.

Thereafter, in a case in which the system control unit 11 completes the readout of the group Gb(3) of the third frame from the imaging element 6, the group Gb(3) is processed and the display data 3b is generated.

Thereafter, at a display update timing t8, in the display memory, the system control unit 11 overwrites the black display data bl on the area corresponding to the display area 23a shown in FIG. 6, overwrites the display data 3b on the area corresponding to the display area 23b shown in FIG. 6, and commands the display controller 22 to perform display update of the display areas 23a and 23b. Therefore, in the display unit 23, the black image BL is displayed in the display area 23a shown in FIG. 6, and the divided image 3B is displayed in the display area 23b shown in FIG. 6.

In the display frame period starting at the update timing t9 subsequent to the update timing t8, in the display unit 23, the divided image 4A based on the group Ga(4) of the fourth frame is displayed in the display area 23a shown in FIG. 6, and the black image BL is displayed in the display area 23b shown in FIG. 6.

As a result of the number of divisions (value of N) of frame being changed in the middle, the average brightness of the images displayed on the display unit 23 in the display frame periods after the update timing t7 in FIG. 10 is lower than the average brightness of the image displayed on the display unit 23 in each of the display frame periods from the update timing t2 to update timing t7.

Therefore, the system control unit 11 performs brightness adjustment to match the average brightness of the images displayed in each display frame period after the timing t7 in which the change in the value of N is reflected in the displayed image with the average brightness of the images displayed in each display frame period before the timing t7.

By performing the brightness adjustment, even in a case in which the value of N is dynamically changed depending on the situation in order to reduce the blurriness of the motion picture, the brightness of the displayed image can be prevented from flickering and the display quality can be improved.

In the above description, as the method of displaying the black image BL on the display unit 23, the method of recording the black display data in the display memory is adopted, but the method is not limited to this.

For example, a method may be adopted in which with respect to the display controller 22, the display area of the display unit 23 in which the black image is to be displayed is designated, and the black image is displayed in the display area by causing the display element in the designated display area to be in a non-driving state.

For example, the display unit 23 may be equipped with a backlight divided for each display area, and the black image may be displayed by causing the backlight in the designated display area to be in the non-driving state, that is, a turning-off state. With this method, it is not necessary to write the black display data on the display memory, so that the image can be displayed at high speed.

Further, in the above description, the case in which the motion picture data output from the imaging element 6 is displayed on the display unit 23 in real time is described as an example, but the display control after FIG. 7 described above, which is performed by the system control unit 11 can be executed in the same manner at the time of the recorded motion picture reproduction control.

Further, in the above description, the imaging element 6 is the CMOS type, but the imaging element 6 may be a charge coupled device (CCD) type.

Hereinafter, a configuration of a smartphone will be described as another embodiment of the imaging device of the present invention.

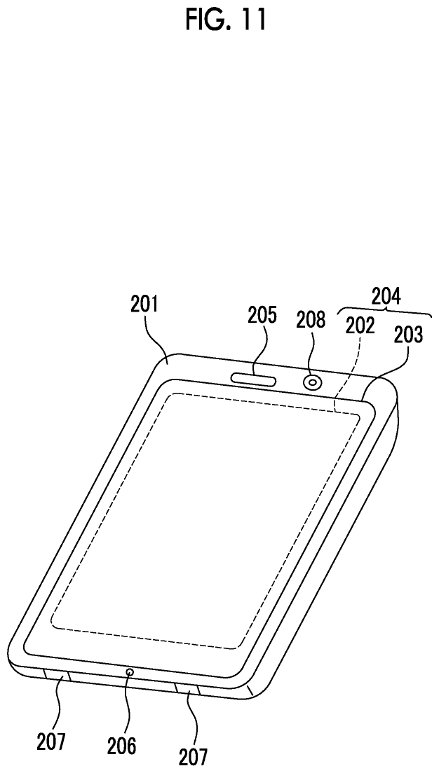

FIG. 11 is a view showing the appearance of a smartphone 200 which is another embodiment of the imaging device of the present invention. The smartphone 200 shown in FIG. 11 comprises a flat plate-shaped housing 201, and a display input unit 204 in which a display panel 202 as a display unit and an operation panel 203 as an input unit are integrated on one surface of the housing 201.

Further, the housing 201 comprises a speaker 205, a microphone 206, an operating unit 207, and a camera unit 208. The configuration of the housing 201 is not limited to this, and for example, a configuration in which the display unit and the input unit are separately provided, or a configuration having a folding structure or a slide mechanism can be adopted.

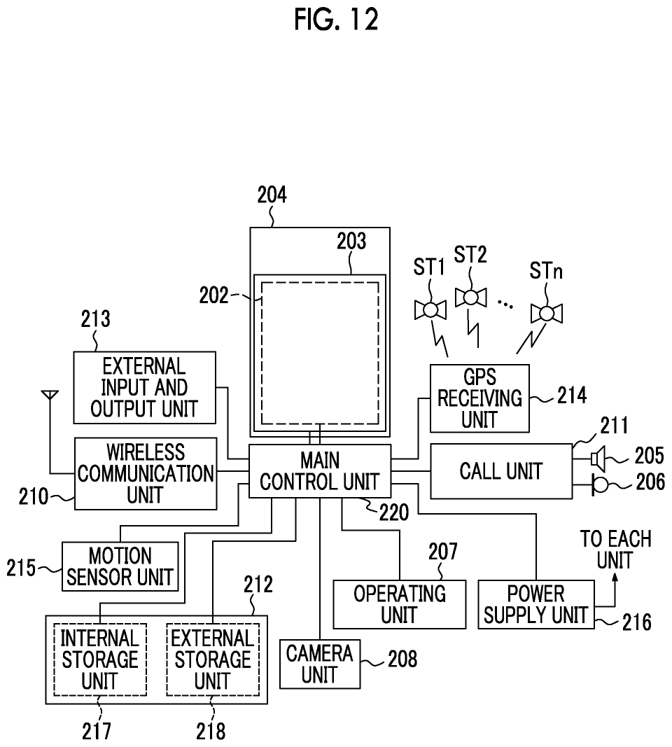

FIG. 12 is a block diagram showing a configuration of the smartphone 200 shown in FIG. 11. As shown in FIG. 12, the smartphone comprises, as main components, a wireless communication unit 210, the display input unit 204, a call unit 211, the operating unit 207, the camera unit 208, a storage unit 212, an external input and output unit 213, a global positioning system (GPS) receiving unit 214, a motion sensor unit 215, a power supply unit 216, and a main control unit 220.

The smartphone 200 has, as a main function, a wireless communication function for performing mobile wireless communication via a base station device BS (not shown) and a mobile communication network NW (not shown).

The wireless communication unit 210 performs wireless communication with the base station device BS accommodated in the mobile communication network NW in accordance with the command of the main control unit 220. Using the wireless communication, the transmission and reception of various file data, such as voice data and image data, e-mail data, and reception of web data, or streaming data, is performed.

The display input unit 204 is a so-called touch panel that displays images (still picture images and motion picture images) or text information under the control of the main control unit 220 to visually transmit the information to a user, and detects the user's operation to the displayed information, and comprises the display panel 202 and the operation panel 203.

The display panel 202 uses a liquid crystal display (LCD) or an organic electro-luminescence display (OELD) as a display device.

The operation panel 203 is a device which is placed to be capable of visually recognizing the image displayed on the display surface of the display panel 202, and is operated by the user's finger or a stylus to detect one or a plurality of coordinates. In a case in which the device is operated by the user's finger or the stylus, detection signals generated due to the operation are output to the main control unit 220. Then, the main control unit 220 detects an operation position (coordinate) on the display panel 202 based on the received detection signals.

As shown in FIG. 12, in the smartphone 200 which is another embodiment of the imaging device of the present invention, the display panel 202 and the operation panel 203 are integrated to configure the display input unit 204, and the operation panel 203 is disposed to completely cover the display panel 202.

In a case in which such a disposition is adopted, the operation panel 203 may have a function of detecting the user's operation even in an area outside the display panel 202. Stated another way, the operation panel 203 may comprise a detection area for the overlapping portion (hereinafter, referred to as a display area) that overlaps the display panel 202, and a detection area for the outer edge portion (hereinafter, referred to as a non-display area) that does not overlap the display panel 202 other than the overlapping portion.

The size of the display area and the size of the display panel 202 may completely match, but it is not always necessary to match the sizes. Also, the operation panel 203 may comprise two sensitive areas in the outer edge portion and the inner portion other than the outer edge portion. Further, the width of the outer edge portion is appropriately designed depending on the size of the housing 201 and the like.

Furthermore, examples of a position detection method adopted in the operation panel 203 include a matrix switch method, a resistive film method, a surface acoustic wave method, an infrared method, an electromagnetic induction method, and a capacitance method, and any method can be adopted.

The call unit 211 comprises the speaker 205 or the microphone 206, and converts the user's voice which is input through the microphone 206 into voice data which can be processed by the main control unit 220 to output the converted voice data to the main control unit 220, or decodes the voice data received by the wireless communication unit 210 or the external input and output unit 213 to output the decoded voice data through the speaker 205.

As shown in FIG. 11, for example, the speaker 205 can be mounted on the same surface as the surface in which the display input unit 204 is provided, and the microphone 206 can be mounted on the side surface of the housing 201.

The operating unit 207 is a hardware key using a key switch or the like, and receives the command of the user. For example, as shown in FIG. 11, the operating unit 207 is mounted on the side surface of the housing 201 of the smartphone 200, and is a push button type switch which is turned on in a case of being pressed with fingers or the like and is turned off by a restoring force such as a spring in a case in which the finger is released.

The storage unit 212 stores a control program and control data of the main control unit 220, application software, address data associated with the name or telephone number of a communication partner, data of transmitted and received e-mails, Web data downloaded from Web browsing, and downloaded content data, and temporarily stores streaming data and the like. The storage unit 212 is configured by an internal storage unit 217 built in the smartphone and an external storage unit 218 which has an attachable and detachable external memory slot.

Each of the internal storage unit 217 and the external storage unit 218 which configure the storage unit 212 is realized by using a storage medium such as a memory of a flash memory type, hard disk type, a multimedia card micro type, or a card type (for example, MicroSD (registered trademark) memory), a random access memory (RAM), a read only memory (ROM), and the like.

The external input and output unit 213 serves as an interface with all of the external devices connected to the smartphone 200, and is directly or indirectly connected to other external devices through communication (for example, a universal serial bus (USB), IEEE 1394, or the like), or a network (for example, the Internet, wireless LAN, Bluetooth (registered trademark), radio frequency identification (RFID), infrared data association (IrDA; registered trademark), ultra wideband (UWB; registered trademark), ZigBee (registered trademark), or the like).

Examples of the external devices connected to the smartphone 200 include a wired/wireless headset, a wired/wireless external charger, a wired/wireless data port, a memory card and a subscriber identity module card (SIM)/user identity module card (UIM) card connected via a card socket, external audio and video devices connected via audio and video input/output (I/O) terminals, wirelessly connected external audio and video, a wired/wireless smartphone, a wired/wirelessly connected personal computer, a wired/wirelessly connected personal computer, earphones, and the like.

The external input and output unit 213 can transmit data transmitted from such external devices to the components inside the smartphone 200, or transmit data inside the smartphone 200 to the external devices.

The GPS receiving unit 214 receives GPS signals transmitted from GPS satellites ST1 to STn in accordance with the command of the main control unit 220, and executes positioning calculation processing based on a plurality of the received GPS signals to detect the position of the smartphone 200 including latitude, longitude, and altitude. In a case in which positional information can be acquired from the wireless communication unit 210 or the external input and output unit 213 (for example, wireless LAN), the GPS receiving unit 214 can detect the position by using the positional information.

The motion sensor unit 215 comprises, for example, a three-axis acceleration sensor, and detects the physical movement of the smartphone 200 in accordance with the command of the main control unit 220. By detecting the physical movement of the smartphone 200, the moving direction or the acceleration of the smartphone 200 is detected. The detection result is output to the main control unit 220.

The power supply unit 216 supplies electric power stored in a battery (not shown) to each unit of the smartphone 200 in accordance with the command of the main control unit 220.

The main control unit 220 comprises a microprocessor, operates in accordance with the control program and the control data stored in the storage unit 212, and controls the units of the smartphone 200 in an integrated manner. The main control unit 220 has a mobile communication control function of controlling the units of the communication system, and an application processing function in order to perform voice communication or data communication through the wireless communication unit 210.

The application processing function is realized by the main control unit 220 which operates in accordance with the application software stored in the storage unit 212. Examples of the application processing function include an infrared ray communication function of controlling the external input and output unit 213 to perform data communication with an opposite device, an e-mail function of performing transmission and reception of e-mail, or a web browsing function of browsing a web page.

Also, the main control unit 220 has an image processing function of displaying a video on the display input unit 204 based on the image data (data of still picture image or motion picture images) such as received data or downloaded streaming data.

The image processing function is a function in which the main control unit 220 decodes the image data, performs image processing on the decoding result, and displays the image on the display input unit 204.

Further, the main control unit 220 executes display control with respect to the display panel 202 and operation detecting control of detecting the user's operation through the operating unit 207 and the operation panel 203.

By executing the display control, the main control unit 220 displays a software key such as an icon or a scroll bar for starting an application software, or displays a window for creating an e-mail.

The scroll bar is a software key for receiving a command to move a displayed portion of the image for a large image that cannot fit in the display area of the display panel 202.

By executing the operation detecting control, the main control unit 220 detects the user's operation through the operating unit 207, receives the operation with respect to the icon and an input of the character string for the input field of the window through the operation panel 203, or receives a scroll request of the displayed image through the scroll bar.

By executing the operation detecting control, the main control unit 220 has a touch panel control function of determining whether the operation position on the operation panel 203 is the overlapping portion (display area) that overlaps the display panel 202 or the outer edge portion (non-display area) that does not overlap the display panel 202 other than the overlapping portion, and controlling the sensitive area of the operation panel 203 and the display position of the software key.

The main control unit 220 can detect a gesture operation on the operation panel 203 and execute a preset function in accordance with the detected gesture operation.

The gesture operation is not a usual simple touch operation, but is an operation of drawing a locus with fingers, designating a plurality of positions at the same time, or combining these operations to draw a locus for at least one from a plurality of positions.

The camera unit 208 includes configurations other than the external memory control unit 20, the storage medium 21, the display unit 23, and the operating unit 14 in the digital camera shown in FIG. 1.

The captured image data generated by the camera unit 208 can be stored in the storage unit 212 or can be output through the external input and output unit 213 or the wireless communication unit 210.

In the smartphone 200 shown in FIG. 11, the camera unit 208 is mounted on the same surface as the display input unit 204, but the mounting position of the camera unit 208 is not limited to this, and the camera unit 208 may be mounted on the back surface of the display input unit 204.

The camera unit 208 can be used for various functions of the smartphone 200. For example, the image acquired by the camera unit 208 can be displayed on the display panel 202, or the image from the camera unit 208 can be used as one of operation input of the operation panel 203.

In a case in which the GPS receiving unit 214 detects the position, the position can be detected by referring to the image from the camera unit 208. Further, the optical axis direction of the camera unit 208 of the smartphone 200 can be determined or the current usage environment can be determined by referring the image from the camera unit 208 without using the three-axis acceleration sensor or using a combination of the image and the three-axis acceleration sensor. Needless to say, the image from the camera unit 208 can be used in the application software.

In addition, the image data of the still picture or the motion picture can be stored in the storage unit 212 with the positional information acquired by the GPS receiving unit 214, the voice information (it may be the text information acquired by converting the voice to the text by the main control unit) acquired by the microphone 206, or the posture information acquired by the motion sensor unit 215, or can be output through the external input and output unit 213 or the wireless communication unit 210.

Even in the smartphone 200 having the above configuration, in a case in which the motion picture data output from the camera unit 208 is displayed on the display panel 202 or in a case in which the motion picture data recorded on the storage medium is displayed on the display panel 202, by performing the display control shown in FIGS. 7 to 10, it is possible to shorten the display time lag and reduce the blurriness of the motion picture.

As described above, the following matters are disclosed in the present specification.

(1)

A display control device in which N is defined as a natural number of 2 or more and a motion picture based on motion picture data is displayed on a display unit at N times rate of a frame rate of the motion picture data, the device comprising a display control unit that divides each frame of the motion picture data into N groups in one direction, and displays each of N divided images based on each of the groups on the display unit by dividing into N consecutive display frame periods, in which P is defined as a numerical value of 1 or more and N-1 or less, and the display control unit displays each of the divided images on a display area of the display unit which corresponds to each of the divided images in N-P display frame periods of the N display frame periods, and displays a specific image different from the motion picture data in P display frame periods of the N display frame periods.

(2)

The display control device according to (1), in which two adjacent groups among the N groups are defined as a first group and a second group, the N display frame periods in which divided images based on the first group are displayed and the N display frame periods in which divided images based on the second group are displayed deviate by one display frame period.

(3)

The display control device according to (1) or (2), in which the motion picture data is output from an imaging element, the one direction is a readout direction of a signal from the imaging element, and the display control unit performs a control of displaying, on the display unit, each of the divided images based on each group by dividing into the N display frame periods each time the group is read out from the imaging element.

(4)

The display control device according to any one of (1) to (3), in which the display control unit variably controls boundary positions of the N groups.

(5)

The display control device according to (4), in which the display control unit controls an average position of the boundary positions of the N groups in a fixed manner.

(6)

The display control device according to any one of (1) to (5), in which the display control unit variably controls a number of divisions of the each frame, and in a case in which the number of divisions is changed, performs brightness adjustment to match an average brightness of the images displayed on the display unit in the display frame periods after the number of divisions is changed with an average brightness of the images displayed on the display unit in the display frame periods before the number of divisions is changed.

(7)

The display control device according to any one of (1) to (5), in which the display control unit variably controls the P, and in a case in which the P is changed, performs brightness adjustment to match an average brightness of the images displayed on the display unit in the display frame periods after the P is changed with an average brightness of the images displayed on the display unit in the display frame periods before the P is changed.

(8)

The display control device according to any one of (1) to (7), in which the display control unit displays the specific image by causing a display element of the display unit to be in a non-driving state.

(9)

An imaging device comprising the display control device according to any one of (1) to (8), an imaging element, and the display unit.

(10)

A display control method in which N is defined as a natural number of 2 or more and a motion picture based on motion picture data is displayed on a display unit at N times rate of a frame rate of the motion picture data, the method comprising a display control step of dividing each frame of the motion picture data into N groups in one direction, and displaying each of N divided images based on each of the groups on the display unit by dividing into N consecutive display frame periods, in which P is defined as a numerical value of 1 or more and N-1 or less, and in the display control step, each of the divided images is displayed on a display area of the display unit which corresponds to each of the divided images in N-P display frame periods of the N display frame periods, and a specific image different from the motion picture data is displayed in P display frame periods of the N display frame periods.

(11)

The display control method according to (10), in which two adjacent groups among the N groups are defined as a first group and a second group, the N display frame periods in which divided images based on the first group are displayed and the N display frame periods in which divided images based on the second group are displayed deviate by one display frame period.

(12)

The display control method according to (10) or (11), in which the motion picture data is output from an imaging element, the one direction is a readout direction of a signal from the imaging element, and in the display control step, a control of displaying each of the divided images based on each group by dividing into the N display frame periods on the display unit is performed each time the group is read out from the imaging element.

(13)

The display control method according to any one of (10) to (12), in which in the display control step, a variable control of boundary positions of the N groups is performed.

(14)

The display control method according to (13), in which in the display control step, a control of an average position of the boundary positions of the N groups in a fixed manner is performed.

(15)

The display control method according to any one of (10) to (14), in which in the display control step, a variable control of a number of divisions of the each frame is performed, and in a case in which the number of divisions is changed, brightness adjustment to match an average brightness of the images displayed on the display unit in the display frame periods after the number of divisions is changed with an average brightness of the images displayed on the display unit in the display frame periods before the number of divisions is changed is performed.

(16)

The display control method according to any one of (10) to (14), in which in the display control step, a variable control of the P is performed, and in a case in which the P is changed, brightness adjustment to match an average brightness of the images displayed on the display unit in the display frame periods after the P is changed with an average brightness of the images displayed on the display unit in the display frame periods before the P is changed is performed.

(17)

The display control method according to any one of (10) to (16), in which in the display control step, the specific image is displayed by causing a display element of the display unit to be in a non-driving state.

(18)

A display control program that causes a computer to execute a display control method in which N is defined as a natural number of 2 or more and a motion picture based on motion picture data is displayed on a display unit at N times rate of a frame rate of the motion picture data, in which the display control method includes a display control step of dividing each frame of the motion picture data into N groups in one direction, and displaying each of N divided images based on each of the groups on the display unit by dividing into N consecutive display frame periods, P is defined as a numerical value of 1 or more and N-1 or less, and in the display control step, each of the divided images is displayed on a display area of the display unit which corresponds to each of the divided images in N-P display frame periods of the N display frame periods, and a specific image different from the motion picture data is displayed in P display frame periods of the N display frame periods.

Although various embodiments have been described above with reference to the drawings, it is needless to say that the present invention is not limited to this. It is obvious that those skilled in the art can conceive various changes or modifications within the scope described in the claims, and naturally, such changes or modifications also belong to the technical scope of the present invention. Further, the components in the embodiments described above may be optionally combined without departing from the spirit of the invention.

The present application is based on a Japanese patent application filed on Feb. 14, 2019 (Japanese Patent Application No. 2019-024793), the contents of which are incorporated herein by reference.

The present invention can be preferably applied to electronic devices having an imaging function and a display function, such as a digital camera or a smartphone.

### EXPLANATION OF REFERENCES

100: digital camera

1: imaging lens

2: stop

4: lens control unit

6: imaging element

60: imaging surface

61: pixel

62: pixel row

63: drive circuit

64: signal processing circuit

8: lens drive unit

9: stop drive unit

10: imaging element drive unit

11: system control unit

14: operating unit

15: memory control unit

16: main memory

17: digital signal processing unit

20: external memory control unit

21: storage medium

22: display controller

23: display unit

23A: display pixel

23B: display pixel row

23a: display area

23b: display area

23c: display area

24: control bus

25: data bus

40: lens device

FL: frame

Ga: group

Gb: group

Gc: group

T: time

200: smartphone

201: housing

202: display panel

203: operation panel

204: display input unit

205: speaker

206: microphone

207: operating unit

208: camera unit

210: wireless communication unit

211: call unit

212: storage unit

213: external input and output unit

214: GPS receiving unit

215: motion sensor unit

216: power supply unit

217: internal storage unit

218: external storage unit

220: main control unit

ST1 to STn: GPS satellite

What is claimed is:

1. A display control device in which N is defined as a natural number of 2 or more and a motion picture based on motion picture data is displayed on a display unit at N times rate of a frame rate of the motion picture data, the device comprising a display control unit that divides each frame of the motion picture data into N groups in one direction, and displays each of N divided images based on each of the groups on the display unit by dividing into N consecutive display frame periods,
wherein P is defined as a numerical value of 1 or more and N-1 or less, and
the display control unit
displays each of the divided images on a display area of the display unit which corresponds to each of the divided images in N-P display frame periods of the N display frame periods, and displays a specific image different from the motion picture data in P display frame periods of the N display frame periods, and
displays, on the display unit, each of the divided images based on each group by dividing into the N display frame periods each time the group is read out.

2. The display control device according to claim 1,
wherein two adjacent groups among the N groups are defined as a first group and a second group, the N display frame periods in which divided images based on the first group are displayed and the N display frame periods in which divided images based on the second group are displayed deviate by one display frame period.

3. The display control device according to claim 1,
wherein the motion picture data is output from an imaging element, and
the one direction is a readout direction of a signal from the imaging element.

4. The display control device according to claim 1,
wherein the display control unit variably controls boundary positions of the N groups.

5. The display control device according to claim 4,
wherein the display control unit controls an average position of the boundary positions of the N groups in a fixed manner.

6. The display control device according to claim 1,
wherein the display control unit variably controls a number of divisions of the each frame, and in a case in which the number of divisions is changed, performs brightness adjustment to match an average brightness of the images displayed on the display unit in the display frame periods after the number of divisions is changed with an average brightness of the images displayed on the display unit in the display frame periods before the number of divisions is changed.

7. The display control device according to claim 1,
wherein the display control unit variably controls the P, and in a case in which the P is changed, performs brightness adjustment to match an average brightness of the images displayed on the display unit in the display frame periods after the P is changed with an average brightness of the images displayed on the display unit in the display frame periods before the P is changed.

8. The display control device according to claim 1,
wherein the display control unit displays the specific image by causing a display element of the display unit to be in a non-driving state.

9. An imaging device comprising:
the display control device according to claim 1;
an imaging element; and
the display unit.

10. A display control method in which N is defined as a natural number of 2 or more and a motion picture based on motion picture data is displayed on a display unit at N times rate of a frame rate of the motion picture data, the method comprising a display control step of dividing each frame of the motion picture data into N groups in one direction, and displaying each of N divided images based on each of the groups on the display unit by dividing into N consecutive display frame periods,
wherein P is defined as a numerical value of 1 or more and N-1 or less, and
in the display control step,
each of the divided images is displayed on a display area of the display unit which corresponds to each of the divided images in N-P display frame periods of the N display frame periods, and a specific image different from the motion picture data is displayed in P display frame periods of the N display frame periods, and
each of the divided images based on each group is displayed on the display unit by dividing into the N display frame periods each time the group is read out.

11. The display control method according to claim 10,
wherein two adjacent groups among the N groups are defined as a first group and a second group, the N display frame periods in which divided images based on the first group are displayed and the N display frame periods in which divided images based on the second group are displayed deviate by one display frame period.

12. The display control method according to claim 10,
wherein the motion picture data is output from an imaging element, and
the one direction is a readout direction of a signal from the imaging element.

13. The display control method according to claim 10,
wherein, in the display control step, a variable control of boundary positions of the N groups is performed.

14. The display control method according to claim 13,
wherein, in the display control step, a control of an average position of the boundary positions of the N groups in a fixed manner is performed.

15. The display control method according to claim 10,
wherein, in the display control step, a variable control of a number of divisions of the each frame is performed, and in a case in which the number of divisions is changed, brightness adjustment to match an average brightness of the images displayed on the display unit in the display frame periods after the number of divisions is changed with an average brightness of the images displayed on the display unit in the display frame periods before the number of divisions is changed is performed.

16. The display control method according to claim 10,
wherein, in the display control step, a variable control of the P is performed, and in a case in which the P is changed, brightness adjustment to match an average brightness of the images displayed on the display unit in the display frame periods after the P is changed with an average brightness of the images displayed on the display unit in the display frame periods before the P is changed is performed.

17. The display control method according to claim 10,
wherein, in the display control step, the specific image is displayed by causing a display element of the display unit to be in a non-driving state.

18. A display control program that causes a computer to execute a display control method in which N is defined as a natural number of 2 or more and a motion picture based on motion picture data is displayed on a display unit at N times rate of a frame rate of the motion picture data,
wherein the display control method includes a display control step of dividing each frame of the motion picture data into N groups in one direction, and displaying each of N divided images based on each of the groups on the display unit by dividing into N consecutive display frame periods,
P is defined as a numerical value of 1 or more and N-1 or less, and
in the display control step,
each of the divided images is displayed on a display area of the display unit which corresponds to each of the divided images in N-P display frame periods of the N display frame periods, and a specific image different from the motion picture data is displayed in P display frame periods of the N display frame periods, and
each of the divided images based on each group is displayed on the display unit by dividing into the N display frame periods each time the group is read out.
